(19) United States
(12) Patent Application Publication
(10) Pub. No.: US 2017/0174093 A1
(43) Pub. Date: Jun. 22, 2017

(54) DEVICE AND METHOD FOR OPERATING AN INDUCTIVE CHARGING SYSTEM

(71) Applicant: Robert Bosch GmbH, Stuttgart (DE)

(72) Inventors: Gerald Heinrich Oettle, Suzhou (CN); Joerg Mecks, Beilstein (DE); Markus Mayer, Heilbronn (DE); Martin Pohlmann, Stuttgart (DE)

(21) Appl. No.: 15/324,482

(22) PCT Filed: Jun. 1, 2015
(86) PCT No.: PCT/EP2015/062072

§ 371 Date: Jan. 6, 2017

(30) Foreign Application Priority Data
Jul. 8, 2014 (DE) 10 2014 213 195.2

(51) Int. Cl. B60L 11/18; H02J 7/02; H02J 7/00

(52) U.S. Cl. CPC B60L 11/1825; B60L 11/182; B60L 11/1846; H02J 7/0021; H02J 7/025

(57) ABSTRACT

The invention relates to a device (15) for operating an inductive charging system (1) for a motor vehicle (2), said device comprising: a fixed primary unit (4) of a charging station (3); a secondary unit (6) that is associated/can be associated with the motor vehicle (2); and means for positioning the motor vehicle (2) having the secondary unit (6) relative to the primary unit (4). According to the invention, the means have at least one ultra wide-band sensor (16, 17, 21).

### BACKGROUND OF THE INVENTION

The invention relates to a device for operating an inductive charging system for a motor vehicle, comprising a stationary primary unit and a secondary unit which is associated/can be associated with the motor vehicle, and comprising means for positioning the vehicle with the secondary unit with respect to the primary unit.

The invention further relates to a method for operating an inductive charging system for a motor vehicle, comprising a stationary primary unit and a secondary unit which is associated with the motor vehicle, wherein the motor vehicle with the secondary unit is aligned with the primary unit.

Modern motor vehicles by now often have an electrical machine as a drive assembly in addition to an internal combustion engine or as an alternative to an internal combustion engine. In order for it to be possible for the electrical machine to be supplied with energy, in particular for motor operation, a chargeable battery or a rechargeable energy store is carried in the motor vehicle. In principle, it is possible to charge the energy store by recuperative operation of the electrical machine. However, since this is not always possible in every case, additional charging systems are generally provided, these additional charging systems allowing the user to charge the electrical storage means at a recharging point or charging station. Currently, the user connects the vehicle to a charging cable of the charging station or charging pole, wherein, to this end, the vehicle first has to be parked on a stopping area which is provided for this purpose. As an alternative, contact-free charging systems are known, which charge the energy store of the motor vehicle by inductive energy transmission. To this end, an inductive charging system has a primary unit and a secondary unit, wherein the primary unit has a primary coil, an inverter which can be operated at high frequency and also a resonance capacitor, and wherein the secondary unit is designed with a secondary coil, a resonance capacitor and a rectifier. The primary unit and the secondary unit each form a resonant circuit, it being possible for the resonant frequencies of said resonant circuits to be tuned to one another. If the primary coil is correspondingly excited by the inverter, a magnetic field is generated, said magnetic field passing through the secondary coil and as a result generating current flow in the secondary coil, which current flow is available for charging the battery. Therefore, the inductive charging system is based on the principle of a transformer.

For an optimum charging process, it is advantageous when the secondary unit is aligned with the primary unit in an optimum manner. The prior art already discloses means which serve to position the motor vehicle with the secondary unit above the primary unit or with respect to the primary unit. This can be achieved, for example, by self-parking systems.

### SUMMARY OF THE INVENTION

The device according to the invention has the advantage that the positioning of the motor vehicle with respect to the primary unit or the inductive charging station can be carried out both at close range and at a distance by the same means. These means can also be used for conventional parking of the motor vehicle on a parking area. The means can also be used to purely identify the motor vehicle in order to authorize, for example, a charging process as a result. The device according to the invention is distinguished in that the means have at least one ultra-wideband sensor. The ultra-wideband sensor is designed to emit electromagnetic pulses or permanent signals which are reflected at an object. The reflected pulses are detected by a receiver of the ultra-wideband sensor and the propagation time of the emitted signals is calculated. The distance is determined by means of measuring the propagation time. Owing to the use of the ultra-wideband, both close-range or fine positioning and positioning at a distance can be performed, so that both a preliminary parking process and final orientation on the parking area with respect to the primary coil can be carried out by the same means. This results firstly in cost advantages and secondly expenditure on calculation is reduced compared to devices in which different means are used for positioning at a distance and close-range positioning. The position of the motor vehicle, which position is ascertained by the device, can be used to provide the driver with instructions as to how he should move the vehicle for optimum positioning, or to control/move the vehicle automatically in order to reach the optimum position.

Short pulses in the nanosecond range or below or signals with a high frequency bandwidth of at least 500 MHz, preferably greater than 1 GHz, are preferably emitted. A high spatial resolution in the centimeter range is achieved as a result. The frequency range of from 2 to 15 GHz, in particular of from 6 to 8.5 GHz, or from 22 to 29 GHz, is preferably proposed here. Furthermore, the ultra-wideband sensor is preferably designed in such a way that the electromagnetic waves are additionally emitted in different polarization directions. This information can be used in order to construct a polarimetric radar system which performs additional object discrimination with the aid of the polarization information. Supplementary ascertaining of the orientation between the vehicle and the charging station in particular is possible as a result.

It is preferably provided that the means have a plurality of ultra-wideband receivers. In principle, it is provided that an ultra-wideband signal is emitted by a transmitter and received by a plurality of receivers in order to be able to determine different propagation times and therefore the position of the motor vehicle in relation to the charging station or primary unit. Therefore, the ultra-wideband sensor preferably comprises at least one ultra-wideband sensor and at least one ultra-wideband receiver, in particular a plurality of ultra-wideband receivers.

According to an advantageous development of the invention, it is provided that an ultra-wideband sensor or ultra-wideband sensors is/are arranged on the motor vehicle and on the primary unit in each case, wherein the respective ultra-wideband sensor can have one or more transmitters and/or one or more receivers. The resolution and, respectively, the accuracy of the device can be increased by the number of ultra-wideband sensors, in particular of ultra-wideband receivers.

According to an advantageous development of the invention, it is provided that the ultra-wideband sensors are designed to communicate with one another. In principle, the position of the motor vehicle or the secondary unit in relation to the primary unit can be determined or at least estimated, as already described above, by means of an ultra-wideband sensor by a signal being emitted and the reflection of said signal being received. However, at least one ultra-wideband sensor is provided both on the motor vehicle and on the charging station in each case, and therefore it is furthermore possible for the ultra-wideband sensors to communicate with one another. Specifically, it is provided in this case that one of the ultra-wideband sensors emits a signal which is detected and evaluated by the other ultra-wideband sensor. To this end, the emitted signal can, for example, be provided with a coding which is detected and read by the other ultra-wideband sensor. Depending on the coding, the receiving ultra-wideband sensor then sends back a signal which may possibly likewise be provided with a coding. In this way, identification of the secondary unit and/or of the primary unit can be carried out, for example, in a simple and rapid manner in order to authorize a charging process. Furthermore, it is preferably provided that a plurality of ultra-wideband receivers or sensors are arranged on the motor vehicle and on the primary unit in each case. In this case, the ultra-wideband receivers can be used not only for positioning purposes, but also for identifying the motor vehicle and/or the charging station and, respectively, the primary unit.

According to an advantageous development of the invention, it is provided that the means have at least one identification device. The identification device can be designed, for example as described above, in order to be able to read a suitable identification feature.

According to an advantageous development of the invention, it is also provided that the means have an odometry detection device of the motor vehicle. Owing to the odometry detection device, by means of which a wheel movement of the motor vehicle and/or a steering angle are detected for example, it is possible to reference or to check the plausibility of the position which is detected/ascertained by the ultra-wideband sensor or the ultra-wideband sensors.

Furthermore, it is preferably provided that the ultra-wideband transmitter and/or receivers of the motor vehicle are/is arranged on the underbody, front or rear of said motor vehicle. In particular, the transmitters and/or receivers are associated with the secondary unit which is likewise arranged on the underbody, in order to allow, in particular, optimum positioning of the secondary unit in relation to the primary unit.

The method according to the invention is distinguished in that the current position of the motor vehicle with respect to the charging station is determined by means of at least one ultra-wideband sensor for a positioning process. In this case, the position of the motor vehicle is intended to be understood to mean not only the distance of the motor vehicle from the charging station but rather also the orientation of the motor vehicle with respect to the charging station, in particular with respect to the primary unit. This results in the advantages which have already been mentioned. Further features and advantages can likewise be gathered from the above description and from the dependent claims.

It is particularly preferably provided that the motor vehicle and/or the charging station are/is identified before a charging process is carried out, in particular before or after the positioning process is carried out. In this case, identification is preferably performed by means of the one or more ultra-wideband sensors which can each have one or more receivers, and/or by means of a separate identification device. In order to position or in order to determine the position of the motor vehicle in relation to the charging station, individual electromagnetic pulses are preferably emitted by the ultra-wideband sensor, reflected pulses are received and the propagation time of said pulses is calculated for the purpose of position determination. As an alternative to the pulses, permanent signals, for example a sinusoidal signal, are preferably emitted. The receiver measures, in the frequency domain, amplitude and phase of the received signal over various frequencies. After a Fourier transformation, this then again gives the data in the time domain. Very short pulses are preferably emitted, as already described above. As an alternative, the identification is preferably performed, as described above, by means of ultra-wideband sensors which communicate with one another.

Electromagnetic waves are particularly preferably emitted in different polarization directions, as described above, in order to carry out additional object discrimination with the aid of the polarization information. The backscattering properties of objects are dependent both on the frequency used and also on the polarization of the incident electromagnetic waves. This is utilized by the preferred refinement of the method in order to identify, for example, the motor vehicle and/or the charging station, so that pairing, that is to say linking of the motor vehicle with the charging station, and/or authorization of a charging process can be carried out.

### BRIEF DESCRIPTION OF THE DRAWINGS

The invention will be explained in greater detail below with reference to the drawing, in which:

FIGS. 1A and 1B show different views of an inductive charging system for a motor vehicle,

FIG. 2 shows a schematic view of a detail of the charging system,

FIG. 3 shows a first exemplary embodiment of an advantageous device for operating the charging system,

FIG. 4 shows a second exemplary embodiment of the device,

FIG. 5 shows a third exemplary embodiment of the device,

FIG. 6 shows a fourth exemplary embodiment of the device,

FIG. 7 shows an advantageous development of the device, and

FIGS. 8A and 8B show simplified flow diagrams of different methods for operating the device.

### DETAILED DESCRIPTION

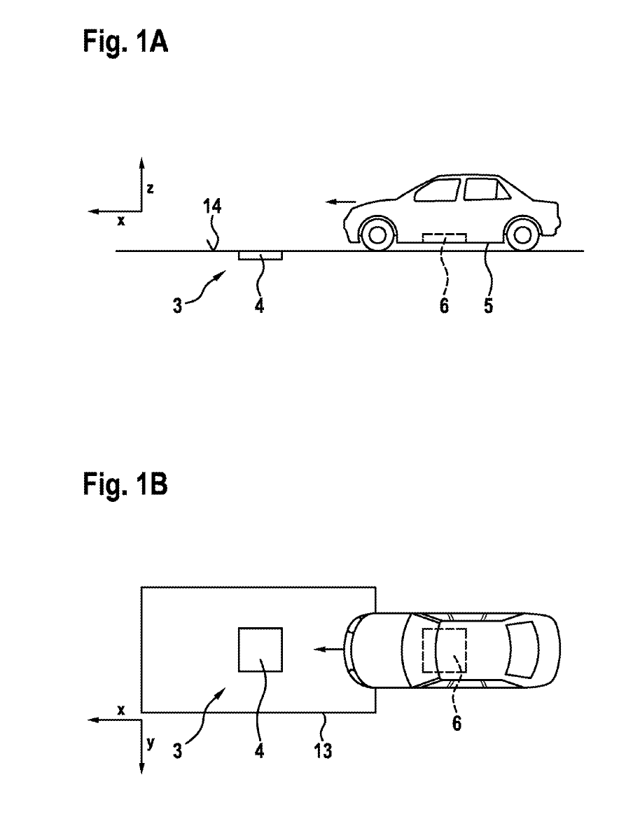

FIG. 1 shows a side view (FIG. 1A) and a plan view (FIG. 1B) of an inductive charging system 1 for a motor vehicle 2. The motor vehicle 2 has at least one electrical machine as a drive device which is connected to an electrical energy store (neither of which is illustrated here). The charging system 1 is provided in order to be able to supply the energy store with energy independently of recuperative operation of the electrical machine, said charging system comprising a stationary charging station 3 having a primary unit 4 and also comprising a secondary unit 6 which is fitted to the underbody 5 of the motor vehicle 2.

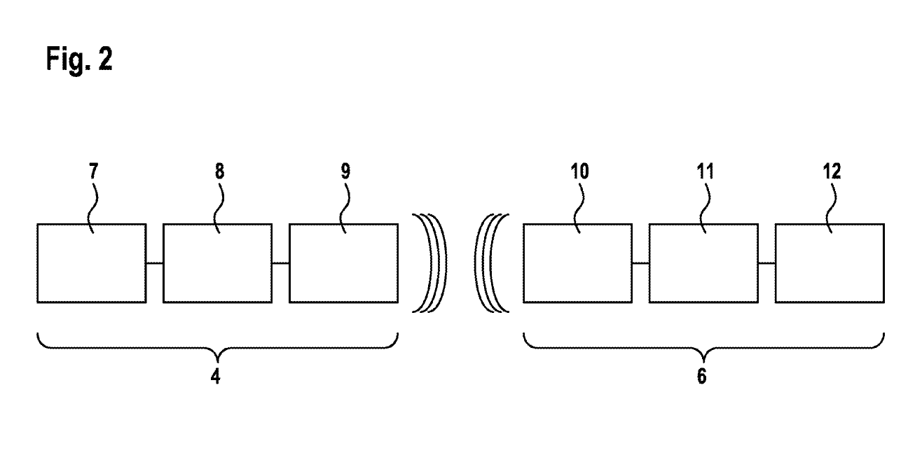

FIG. 2 shows a simplified illustration of the basic design of the charging system 1. The primary unit 4 has a rectifier 7 which converts an AC voltage of a power supply system into a DC voltage. Furthermore, the primary unit 4 has an inverter 8 which is operated at high frequency in order to set a desired AC voltage in a primary coil 9 from the DC voltage. The primary coil 9 forms, in particular together with a resonance capacitor, a primary resonant circuit of the charging system 1.

The secondary unit 6 has a secondary resonant circuit which is formed by a secondary coil 10 together with a corresponding resonance capacitor. The resonant circuits of the secondary unit and of the primary unit are expediently tuned to one another. The secondary coil 10 is connected to a rectifier 11 which is connected to the rechargeable energy store 12 of the motor vehicle.

The charging system 1 is therefore based on the principle of a transformer, wherein a power is transmitted from the primary unit 4 to the secondary unit 6 by means of an alternating magnetic field, wherein the primary coil 9 and the secondary coil 10 are coupled to one another by means of magnetic resonance. Setting an AC voltage by means of the inverter 8 in the primary coil 9 generates a magnetic field which passes through the secondary coil 10 and creates a corresponding current flow there. The rectifier 11 converts the AC voltage or the alternating current into a DC voltage or direct current for charging the energy store 12.

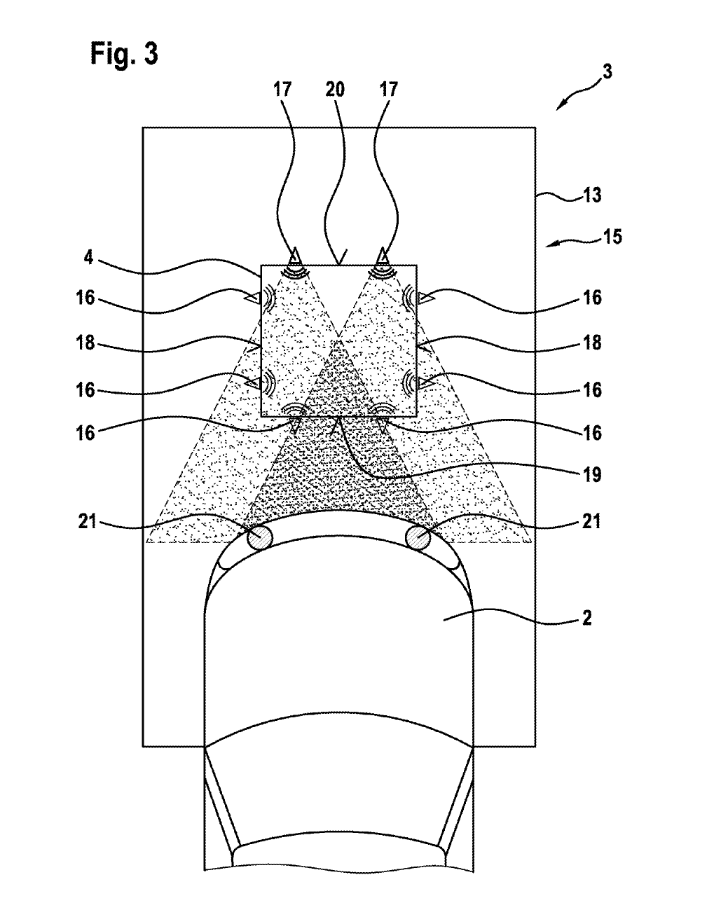

As is clear from FIGS. 1A and 1B, carrying out a charging process requires the secondary unit 6 to be aligned with or positioned in relation to the primary unit 4 in such a way that the magnetic field which is generated by the coil 9 passes through the secondary coil 10. In order to facilitate alignment, the charging station 3 can be identified, for example, with a marking 13 on the roadway surface 14, as shown in FIGS. 1A and 1B. In order to simplify the positioning and, in particular, also to allow said positioning to be performed automatically, a device 15 for operating the charging system 1 is presented in the text which follows. The device 15 provides that an ultra-wideband system is used for positioning the motor vehicle 2. FIGS. 3 to 7 illustrate different exemplary embodiments of the device 15, in each case in a plan view of the motor vehicle 2 and the charging station 3. FIG. 3 shows the design of the device 1 according to a first exemplary embodiment, in which a plurality of ultra-wideband sensors 16 and 17 are associated with the primary unit 4. In this case, in each case two of the ultra-wideband sensors 16 are provided on opposite longitudinal sides 18 of the primary unit 4 (which is designed, for example, as a charging plate), a further pair of ultra-wideband sensors 16 are provided on the end side 19 which faces the motor vehicle 2, and the two ultra-wideband sensors 17 are provided on the end side 20 which is averted from the motor vehicle 2 in the present exemplary embodiment. FIG. 3 also illustrates the working regions of the ultra-wideband sensors 17 which are oriented in the direction of the motor vehicle 2. Overall, all of the ultra-wideband sensors 16, 17 are oriented in the direction of the primary unit 4.

Two ultra-wideband sensors 21 are likewise provided on the front end of the motor vehicle 2, the working regions of said ultra-wideband sensors being oriented forward in the direction of travel of the motor vehicle 2. Each of the ultra-wideband sensors 16, 17, 21 has at least one transmitter and at least one receiver, possibly a plurality of receivers.

The ultra-wideband sensors 16, 17, 21 preferably transmit individual electromagnetic pulses. These pulses are reflected at objects which differ from the propagation medium (for example air) in terms of their electrical properties. The reflected pulses are registered/detected by the ultra-wideband sensors 16, 17, 21 and the propagation time of said pulses is determined. The distance of the respective sensor from the object at which the pulses have been reflected is then determined by means of measuring the propagation time. Instead of the pulses, it is also possible to emit permanent signals, for example a sinusoidal signal. The receiver then measures, in the frequency domain, amplitude and phase of the received signal in series for different frequencies. In particular after a Fourier transformation, this then again gives readable data in the time domain.

As an alternative, it is provided that the ultra-wideband sensors 21 on the vehicle communicate with the ultra-wideband sensors 16, 17 of the charging station 3. To this end, at least one of the ultra-wideband sensors 16, 17, 21 emits a signal which is provided, in particular, with a coding for identification purposes. Another of the ultra-wideband sensors 16, 17, 21 detects the signal, reads the coding and can decide, for example, whether the detected signal is a permissible signal, that is to say the signal of a secondary unit which is suitable for the primary unit for example. If this is the case, the receiving ultra-wideband sensor emits a response signal in order to confirm the positive identification, so that a charging process can be authorized.

Very short pulses, in particular in the nanosecond or in the sub-nanosecond range, or signals with a high frequency bandwidth of at least 500 MHz, preferably greater than 1 GHz, are preferably emitted. A high spatial resolution in the centimeter range is achieved as a result. The frequency range of from 2 to 15 GHz, in particular of from 6 to 8.5 GHz, or from 22 to 29 GHz, is preferably proposed here.

In addition, electromagnetic waves can be emitted in different polarization directions by one or more of the ultra-wideband sensors 16, 17, 21. This information can be used in order to construct a polarimetric radar system which performs additional object discrimination with the aid of the polarization information. The property of objects that an incident electromagnetic wave is reflected depending on the polarization is utilized in this case. Angular resolution of the device 15 is achieved with the aid of the combination of different sensors. The signals are offset in relation to one another, as required, so adeptly that the area to be monitored can be preferably completely scanned or detected.

In the case of the first exemplary embodiment according to FIG. 3, it is provided that the device 15 is integrated substantially into the charging station 3. The working region of the ultra-wideband sensors 16, 17 preferably extends beyond the charging plate and, respectively, the primary unit 4. The ultra-wideband sensors 16 which are fitted to the longitudinal sides 18 serve, in particular, for foreign-object recognition on the primary unit 4. The ultra-wideband sensors 17 and 21 serve, in particular, to position the motor vehicle 2 with its secondary unit 6 above the primary unit 4, wherein the ultra-wideband sensors 17 are also used for foreign-object recognition, and the ultra-wideband sensors 21 serve for coupling and, respectively, authorizing the charging process.

Elements which are already known from the preceding figures are provided with the same reference symbols, and therefore reference is made to the above description in this respect. Essentially only the differences are intended to be discussed in the text which follows.

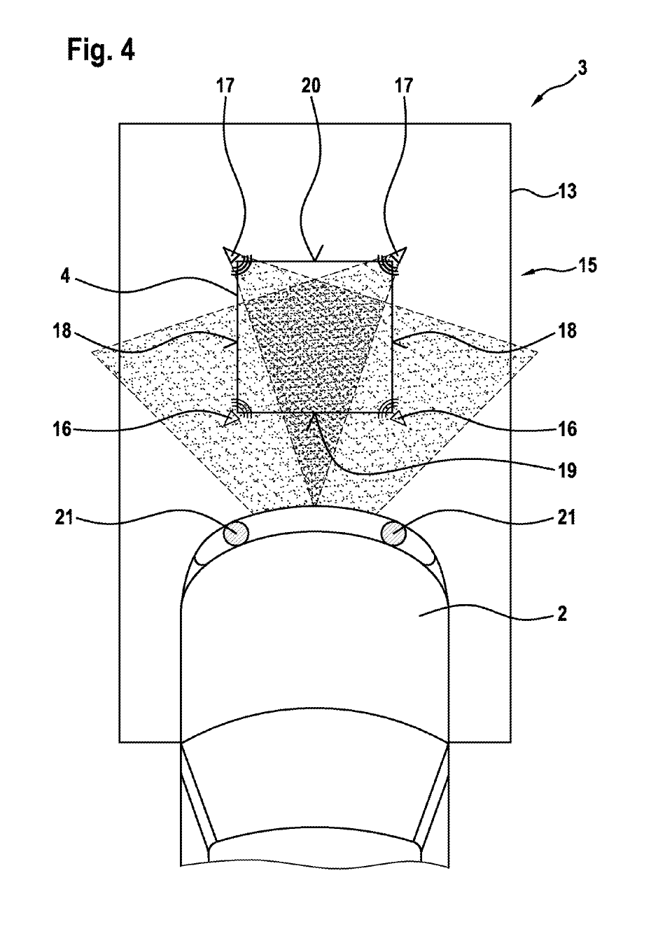

FIG. 4 shows a second exemplary embodiment of the device 15 which differs from the preceding exemplary embodiment in that only four ultra-wideband sensors 16, 17 are associated with the primary unit 4, wherein the ultra-wideband sensors 16, 17 are each assigned to a corner of the rectangular, and in particular square, primary unit 4, so that the working region and, respectively, the respective main axis run through the center of the primary unit 4 at least in projection. The manner of operation of the device 15 according to the exemplary embodiment of FIG. 4 corresponds to that of the preceding exemplary embodiment. Only the number of ultra-wideband sensors 16 has been reduced, as a result of which costs and computational complexity are reduced on the one hand but the resolution of position detection is also reduced on the other hand. As an alternative, it would also be feasible to orient the ultra-wideband sensors 16 on the end side 19 in the direction of the approaching motor vehicle 2 and/or to orient the ultra-wideband sensors 17 such that they face one another.

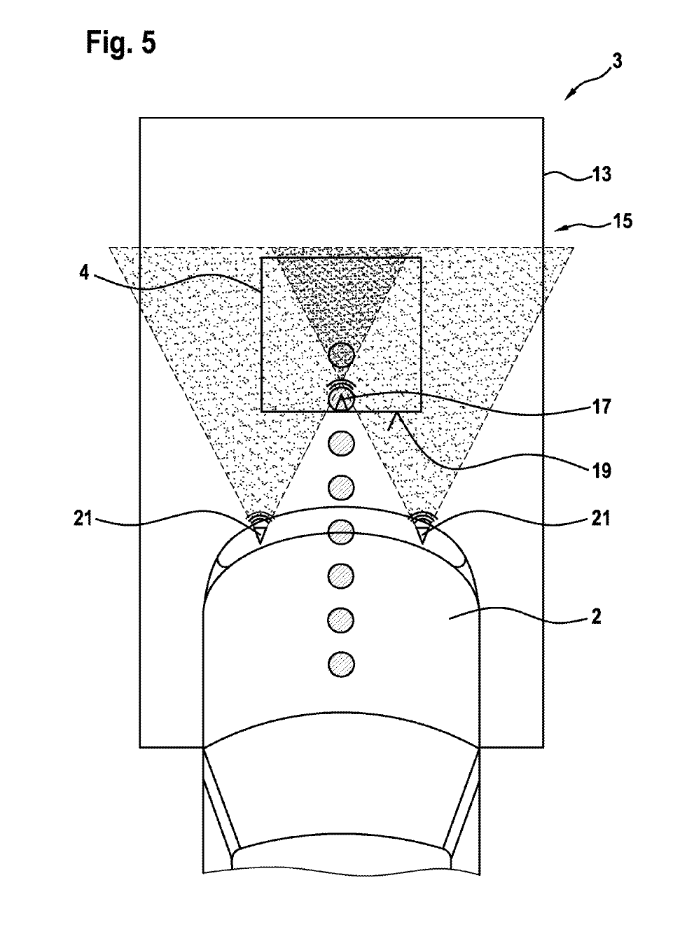

FIG. 5 shows a third exemplary embodiment of the device 15, wherein only one ultra-wideband sensor 17 is provided on the primary unit 4, said ultra-wideband sensor being situated on the end side 19 which faces the motor vehicle 2 and the working region of said ultra-wideband sensor facing away from the primary unit 4 in the direction of the approaching vehicle 2. In this case, the ultra-wideband sensor 17 serves as a guideline for the motor vehicle 2. The ultra-wideband sensors 21 of the motor vehicle 2 further serve for positioning and coupling and, respectively, authorizing the motor vehicle 2. To this end, the ultra-wideband sensors 21 are preferably arranged on the underbody 5 of the motor vehicle 2.

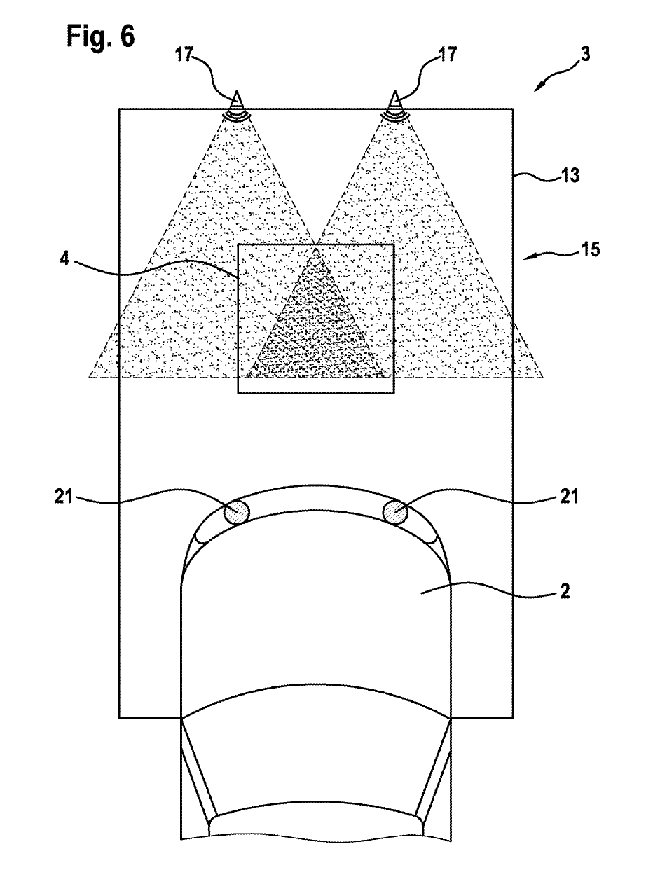

FIG. 6 shows a fourth exemplary embodiment of the device 15, in which the two ultra-wideband sensors 17 are not directly associated with the primary unit 4, but rather with the charging station 3 and, respectively, with that end of the charging station 3 which is indicated by the marking 13, and are oriented in such a way that the working regions extend over the primary unit 4 and overlap, as shown in FIG. 6. In this case too, the ultra-wideband sensors 17, 21 are operated, as described above, in order to position the motor vehicle 2. The ultra-wideband sensors 17 are expediently integrated into the parking space or stopping region of the charging station 3, which parking space or stopping region is indicated by the marking 13, in such a way that they detect the critical region, that is to say in particular the region of the primary unit 4.

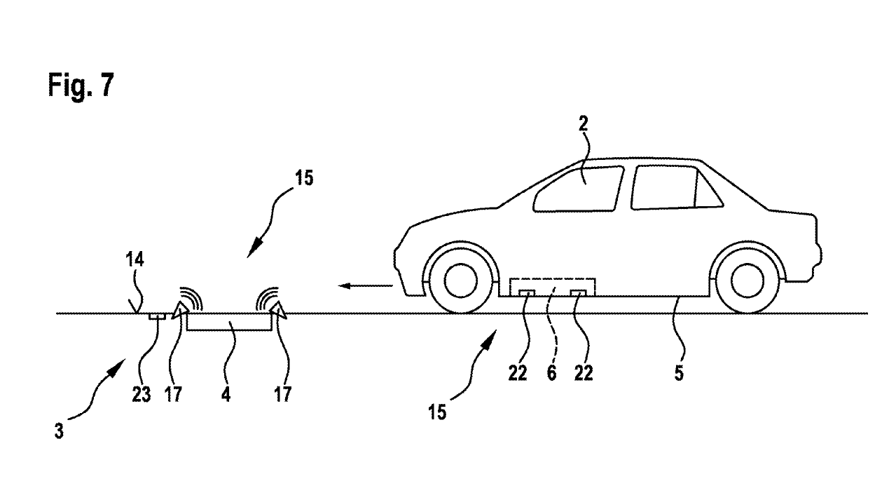

FIG. 7 shows an exemplary side view of the device 15 from FIGS. 3 and 4. The secondary unit 6 is arranged together with the ultra-wideband sensors 21 on the vehicle underbody 5 of the motor vehicle 2. The primary unit 4 is arranged integrated into the roadway 14 as a charging plate, wherein, on the primary unit 4, the ultra-wideband sensors 17 are arranged both on the end side 19 which faces the motor vehicle 2 and also on the end side 20 which is averted from the motor vehicle. In this case, the working region of the ultra-wideband sensors 17 preferably extends beyond the primary unit 4. The detection range of the ultra-wideband sensors 17 is prespecified depending on a desired “active region” within which it is intended that the motor vehicle 2 can be positioned by means of the ultra-wideband sensors.

According to the exemplary embodiment of FIG. 7, it is also provided that the secondary unit 6 is provided with identifiers for unambiguous features 22 which allow the motor vehicle 2 and, respectively, the secondary unit 6 to be identified by the charging station 3. An identification device 23 which detects the features 22 is provided for this purpose.

It goes without saying that it is also feasible, as an alternative or in addition, to not provide the features 22 on the motor vehicle 2, but rather on the charging station 3 or the roadway 14. In this case, the features 22 do not necessarily have to be oriented such that they point downward toward the roadway 14 or upward in the direction of the underbody 5 of the motor vehicle 2. Rather, it is also feasible to fit the features 22 laterally on the motor vehicle 2 and/or the charging station 3. The identification unit 23 then has to be correspondingly designed or oriented in order to be able to detect the features 22. When the device 15 is integrated on the motor vehicle 2, it is preferably provided that when charging is desired, the device 15 is activated by the driver or automatically when it arrives at a charging station. Arrival at the charging station can be ascertained, for example, by comparison with navigation data of a navigation system of the motor vehicle 2. In respect of the charging station 3, it is feasible for the device 15 or the ultra-wideband sensors 16 and/or 17 provided there to emit signals at specific, preferably regular, intervals or continuously.

As an alternative, it is preferably provided that the identification device 23 is jointly formed by the ultra-wideband sensors 16, 17, 21, as described above. In this case, it is provided, in particular, that the ultra-wideband sensors 16, 17, 21, or at least one of these, emits a signal with a coding for identification purposes, which signal is detected by another ultra-wideband sensor 16, 17, 21 and may be confirmed or at least evaluated.

The positioning method can be carried out differently depending on where the ultra-wideband sensors 16, 17, 21 are arranged. In principle, the following steps, of which the order can also be different, are important: authorization, positioning and establishing communication. In order to make the charging process as simple as possible, unambiguous association between charging station 3 and motor vehicle 2 is advantageously and possibly necessarily required before establishing communication.

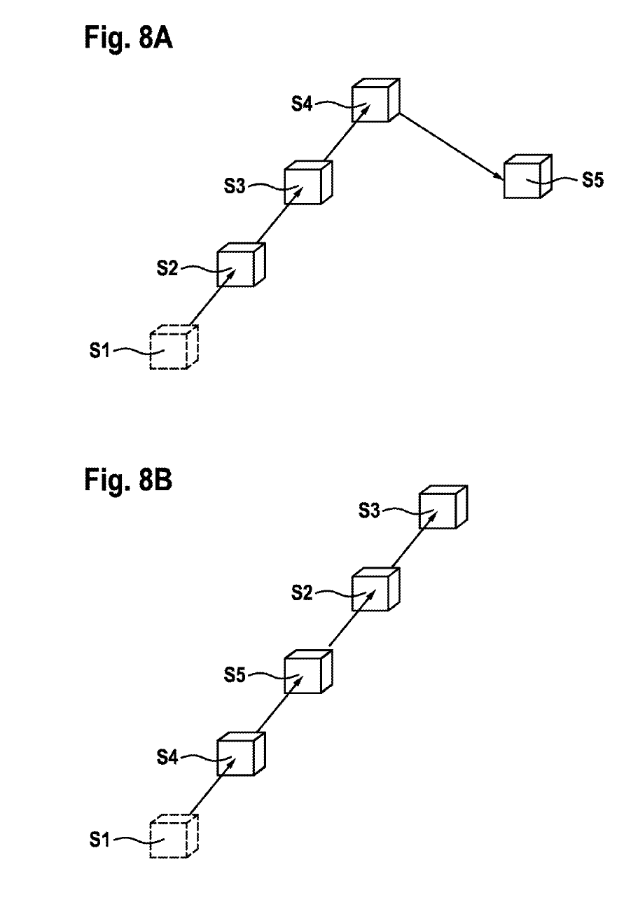

FIGS. 8A and 8B show different sequences of the method for operating the charging system 1. According to FIG. 8A, the charging station 3 is selected by means of a navigation system and driven to in a first step S1. In a subsequent step S2, positioning at a distance is performed, in particular by means of the device 15, and in a subsequent step S3 fine adjustment of the secondary unit 6 in relation to the primary unit 4, likewise by means of the device 15, is performed. As soon as the motor vehicle 2 is correspondingly aligned with the charging station 3, authorization takes place in a step S4. To this end, in particular, the features 22 on the motor vehicle 2 or on the charging station 3 are detected and read in order to carry out identification of motor vehicle 2 and/or charging station 3. As soon as authorization is performed, communication is established between the motor vehicle 2 and the charging station 3 in a step S5, said communication serving, for example, to detect the state of charge of the electrical storage means of the motor vehicle 2 and to actuate the charging station 3 depending on said state of charge.

The method in FIG. 8B differs from the preceding method in that authorization, that is to say step S4, and establishing communication, that is to say step S5, are carried out before positioning at a distance according to step S2.

Furthermore, it is feasible to initially only determine the position of the motor vehicle 2 and, respectively, the secondary unit 6 in relation to the primary unit 4 by means of the device 15 and then to position the motor vehicle 2 with the aid of odometry data. However, as an alternative, the odometry data can also be used as referencing means for positioning by means of the device 15.

In principle, the device 15 can even be used when it has only one ultra-wideband transmitter and a plurality of ultra-wideband receivers which are formed by one or more ultra-wideband sensors 16, 17, 21. The ultra-wideband sensors 16, 17, 21 are preferably operated continuously in order to ensure a high resolution. The ultra-wideband sensors, that is to say the transmitter and/or receivers, can be integrated into the charging station 3 and, respectively, into the motor vehicle 2 in different fitting variants. For the purpose of positioning the motor vehicle 2 and, respectively, the secondary unit 6, the distance from an unambiguous transmitter/receiver on the opposite side is continuously detected. A standardized arrangement of the ultra-wideband sensors on the charging station 3 would be advantageous.

During a parking process or positioning process, an existing environment sensor system of the motor vehicle 2, for example ultrasound sensors, a camera device or a radar device, can be used in order to prevent collisions with objects in the environment and to indicate to the user whether the target position, which is ascertained as described above, on the charging station can be driven to. The ascertained position can be used, for example, to assist manual parking by the driver by providing corresponding acoustic or visual signals, to facilitate semi-automatic parking with the aid of active steering intervention operations and/or acceleration operations or to carry out a fully automatic parking process.

1. A device (15) for operating an inductive charging system (1) for a motor vehicle (2), comprising a stationary primary unit (4) of a charging station (3) and comprising a secondary unit (6) which is associated with the motor vehicle (2) and also comprising a system having at least one ultra-wideband sensor (16, 17, 21), wherein the system enables positioning the motor vehicle (2) with the secondary unit (6) in relation to the primary unit (4).

2. The device as claimed in claim 1, characterized in that the system has a plurality of ultra-wideband receivers (16, 17, 21).

3. The device as claimed in claim 1, characterized in that at least one ultra-wideband sensor (16, 17, 21) is arranged on the motor vehicle and on the primary unit (4) in each case.

4. The device as claimed in claim 1, characterized in that the ultra-wideband sensors (16, 17, 21) are designed configured to communicate with one another.

5. The device as claimed in claim 1, characterized in that a plurality of ultra-wideband sensors (16, 17, 21) are arranged on the motor vehicle (2) and on the primary unit (4) in each case.

6. The device as claimed in claim 1, characterized in that the system has at least one identification device (23).

7. The device as claimed in claim 1, characterized in that the system has an odometry detection device.

8. A method for operating an inductive charging system for a motor vehicle, comprising a stationary primary unit (4) of a charging station (3) and a secondary unit (6) which is associated with the motor vehicle (2), wherein the motor vehicle (2) with the secondary unit (6) is positioned with respect to the primary unit (4), characterized in that a current position of the motor vehicle (2) is determined by 1 at least one ultra-wideband sensor (16, 17, 21).

9. The method as claimed in claim 8, characterized in that the identities of the motor vehicle (2) and/or of the charging station (3) are checked before the charging process is carried out.

10. The method as claimed in claim 1, characterized in that the at least one ultra-wideband sensor (16, 17, 21) is actuated to emit individual electromagnetic pulses or a permanent signal.

11. The method as claimed in claim 8, characterized in that the identity of the motor vehicle (2) is checked before the charging process is carried out.

12. The method as claimed in claim 8, characterized in that the identity of the charging station (3) is checked before the charging process is carried out.
